(19) United States
(12) Patent Application Publication
(10) Pub. No.: US 2026/0072973 A1
(43) Pub. Date: Mar. 12, 2026

(54) REPORT GENERATION FROM MULTIPLE TABLES

(71) Applicant: Truist Bank, Charlotte, NC (US)

(72) Inventors: Cary Nutting, Charlotte, NC (US); Charles Scott, Charlotte, NC (US)

(73) Assignee: Truist Bank, Charlotte, NC (US)

(21) Appl. No.: 19/324,062

(22) Filed: Sep. 9, 2025

Related U.S. Application Data
(60) Provisional application No. 63/692,367, filed on Sep. 9, 2024.

(51) Int. Cl. G06F 16/34; G06F 16/2455

(52) U.S. Cl. CPC G06F 16/345; G06F 16/24556

(57) ABSTRACT

An automated system and method for transforming data from a plurality of source data structures into a cohesive format for operational report generation. The automated system and method performs operations including: identifying a plurality of source data structures; extracting data from the plurality of source data structures as extracted data; aggregating the extracted data as aggregated data; summarizing the aggregated data; and generating, based on the summarized data, a data structure in a predefined format as a generated data structure.

### CROSS-REFERENCE TO RELATED APPLICATIONS

The present application claims the benefit of priority to U.S. Provisional Patent Application No. 63/692,367 (filed on September 9, 2024), which is hereby incorporated by reference in its complete entirety.

### TECHNICAL FIELD

Embodiments generally relate to automated operational report generation. More particularly, embodiments relate to a software delivery lifecycle (SDLC) compliance reporting solution for transforming data from a plurality of source data structures into a cohesive format for operational report generation.

### BACKGROUND

SDLC framework controls may be governed and managed on ServiceNow® in a custom strategic portfolio management application (formerly known as IT Business Management). In a custom-built application on the ServiceNow® platform, the use of multiple, complex workflows and tables to manage processes presents challenges for effective reporting using out of the box ServiceNow® reports and dashboards. Current reporting delivered using EXCEL® based tools and templates to extract data from ServiceNow, aggregate the data, and prepare visualizations and summaries take a significant amount of time to prepare the EXCEL reports (e.g., 32 hours per month), involve many separate tabs for user accessed reports (e.g., 42 separate tabs plus 25 supporting tabs), and provide the reports to a high number of users (e.g., approximately 2000 leaders and delivery team members). Additionally, using ServiceNow® out-of-box (OOB) reporting tools, joining data from more than two tables resulted in thousands of duplicate records. Current limitations are due to the custom architectural design of the tables used in the workflows for key processes required for reporting in the custom-built ServiceNow® application. This condition results in “many to one” and “many to many” relationships between the tables.

### SUMMARY

Embodiments are directed to an automated report generation system that transforms data from multiple source data structures into a cohesive format for operational reporting. The system identifies a plurality of source data structures, extracts data from each, aggregates the extracted data, summarizes the aggregated data, and generates a data structure in a predefined format such as a list chart. The predefined format may include calculated columns, score reports, or trend reports. Calculated scores and Key Performance Indicator (KPI) values are generated from the summarized data. The system may deploy a software model for aggregation and extract data either sequentially or simultaneously. A graphical user interface (GUI) is generated to display the report on a client device's UI. The system automatically updates the generated data structure and stores it at a storage location. This is implemented using JavaScript to customize charts and reports, consolidating data into a comprehensive dashboard in-platform with filter options and design consistency.

The system provides a streamlined, automated approach to data aggregation and report generation within a ServiceNow environment, significantly reducing the manual effort and complexity traditionally associated with managing data from multiple interrelated tables. By extracting, aggregating, and summarizing data from diverse source structures into a predefined format—such as a list chart with calculated columns, score reports, or trend reports—the system eliminates the need for extensive user intervention and minimizes the risk of data duplication and inconsistency. This is achieved through a software model that enables both sequential and simultaneous data extraction, ensuring efficient processing and real-time or near-real-time updates to the generated reports. The use of JavaScript for customizing in-platform visualizations allows for dynamic, filterable dashboards that maintain design consistency and provide a unified user experience, in contrast to fragmented, static spreadsheets that require extensive manual manipulation and maintenance. The system's ability to automatically update and store the generated data structure further enhances operational efficiency and ensures data accuracy over time.

In one embodiment, at least one computer readable storage medium comprising a plurality of instructions, which when executed by a computing system, cause the computing system to identify a plurality of tables, wherein two or more of the plurality of tables have a one-to-one relationship, a one-to-many relationship and a many-to-many relationship with one another, aggregate data from the plurality of tables, summarize the data, and generate a list chart based on the summarized data, wherein the list chart includes one or more of calculated columns, score reports or trend reports.

In accordance with one or more embodiments set forth, illustrated and described herein, a method for optimized report generation may comprise one or more of the following: identifying a plurality of source data structures; extracting data from each identified source data structure in the plurality of source data structures as extracted data; aggregating the extracted data as aggregated data; summarizing the aggregated data; and generating, based on the summarized data, a data structure in a predefined format as a generated data structure.

In accordance with one or more embodiments set forth, illustrated and described herein, a method for optimized report generation may comprise one or more of the following: extracting data from a plurality of target source data structures as extracted data; aggregating the extracted data as aggregated data; summarizing the aggregated data; and generating, based on the summarized data, a data structure in a predefined format as a generated data structure

In accordance with one or more embodiments set forth, illustrated and described herein, at least one computer readable storage medium comprising a plurality of instructions, which when executed by a computing system, cause the computing system to perform operations including one or more of the following: identifying a plurality of source data structures; extracting data from each identified source data structure in the plurality of source data structures as extracted data; aggregating the extracted data as aggregated data; summarizing the aggregated data; and generating, based on the summarized data, a data structure in a predefined format as a generated data structure.

In accordance with one or more embodiments set forth, illustrated and described herein, at least one computer readable storage medium comprising a plurality of instructions, which when executed by a computing system, cause the computing system to perform operations including one or more of the following: extracting data from a plurality of target source data structures as extracted data; aggregating the extracted data as aggregated data; summarizing the aggregated data; and generating, based on the summarized data, a data structure in a predefined format as a generated data structure.

In accordance with one or more embodiments set forth, illustrated and described herein, a computing system comprises one or more of the following: one or more processors and a non-transitory memory coupled to the one or more processors, the non-transitory memory including a set of executable instructions of computer-executable program code, which when executed by the one or more processors, cause the one or more processors to perform operations including: identifying a plurality of source data structures; extracting data from each identified source data structure in the plurality of source data structures as extracted data; aggregating the extracted data as aggregated data; summarizing the aggregated data; and generating, based on the summarized data, a data structure in a predefined format as a generated data structure.

In accordance with one or more embodiments set forth, illustrated and described herein, a computing system comprises one or more of the following: one or more processors and a non-transitory memory coupled to the one or more processors, the non-transitory memory including a set of executable instructions of computer-executable program code, which when executed by the one or more processors, cause the one or more processors to perform operations including: extracting data from a plurality of target source data structures as extracted data; aggregating the extracted data as aggregated data; summarizing the aggregated data; and generating, based on the summarized data, a data structure in a predefined format as a generated data structure.

In accordance with the one or more embodiments, the plurality of source data structures comprise relational tables.

In accordance with the one or more embodiments, two or more of the plurality of source data structures have a one-to-one relationship.

In accordance with the one or more embodiments, two or more of the plurality of source data structures have a one-to-many relationship.

In accordance with the one or more embodiments, two or more of the plurality of source data structures have a many-to-many relationship.

In accordance with the one or more embodiments, the generated data structure comprises a list chart.

In accordance with the one or more embodiments, the predefined format comprises calculated columns.

In accordance with the one or more embodiments, the predefined format comprises score reports.

In accordance with the one or more embodiments, the predefined format comprises or trend reports.

In accordance with the one or more embodiments, further comprising generating calculated scores from the summarized aggregated data.

In accordance with the one or more embodiments, the list chart includes the generated calculated scores.

In accordance with the one or more embodiments, further comprising generating Key Performance Indicator (KPI) values from the summarized aggregated data.

In accordance with the one or more embodiments, the list chart includes the generated KPI values.

In accordance with the one or more embodiments, aggregating the extracted data comprises deploying a software model to aggregate the extracted data as the aggregated data.

In accordance with the one or more embodiments, extracting the data from the plurality of source data structures comprises sequentially extracting the data from the plurality of source data structures.

In accordance with the one or more embodiments, extracting the data from the plurality of source data structures comprises simultaneously extracting the data from the plurality of source data structures.

In accordance with the one or more embodiments, further comprising generating a graphical user interface (GUI) to display the generated data structure on a user interface (UI) of a client device.

In accordance with the one or more embodiments, further comprising automatically updating the generated data structure as an updated data structure and storing the updated data structure at a storage location.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein;

FIG. 2 illustrates a block diagram of the mobile device of FIG. 1;

FIG. 3 illustrates a block diagram of the personal computing device of FIG. 1;

FIG. 4 illustrates a block diagram of the one or more enterprise servers of the server computing system of FIG. 1;

FIG. 5 illustrates a block diagram of an example of a data model having complex relationships in accordance with one or more embodiments set forth and described herein; and

FIG. 6 illustrates a block diagram of an example of a SDLC compliance reporting solution in accordance with one or more embodiments set forth and described herein.

FIGS. 7 and 8 respectively illustrate a method for optimized report generation, in accordance with one or more embodiments set forth and described herein.

### DETAILED DESCRIPTION

Embodiments are directed to an automated report generation system that transforms data from multiple source data structures into a cohesive format for operational reporting. The system identifies a plurality of source data structures, extracts data from each, aggregates the extracted data, summarizes the aggregated data, and generates a data structure in a predefined format such as a list chart. The predefined format may include calculated columns, score reports, or trend reports. Calculated scores and Key Performance Indicator (KPI) values are generated from the summarized data. The system may deploy a software model for aggregation and extract data either sequentially or simultaneously. A graphical user interface (GUI) is generated to display the report on a client device's UI. The system automatically updates the generated data structure and stores it at a storage location. This is implemented using JavaScript to customize charts and reports, consolidating data into a comprehensive dashboard in-platform with filter options and design consistency.

The system provides a streamlined, automated approach to data aggregation and report generation within a ServiceNow environment, significantly reducing the manual effort and complexity traditionally associated with managing data from multiple interrelated tables. By extracting, aggregating, and summarizing data from diverse source structures into a predefined format—such as a list chart with calculated columns, score reports, or trend reports—the system eliminates the need for extensive user intervention and minimizes the risk of data duplication and inconsistency. This is achieved through a software model that enables both sequential and simultaneous data extraction, ensuring efficient processing and real-time or near-real-time updates to the generated reports. The use of JavaScript for customizing in-platform visualizations allows for dynamic, filterable dashboards that maintain design consistency and provide a unified user experience, in contrast to fragmented, static spreadsheets that require extensive manual manipulation and maintenance. The system's ability to automatically update and store the generated data structure further enhances operational efficiency and ensures data accuracy over time.

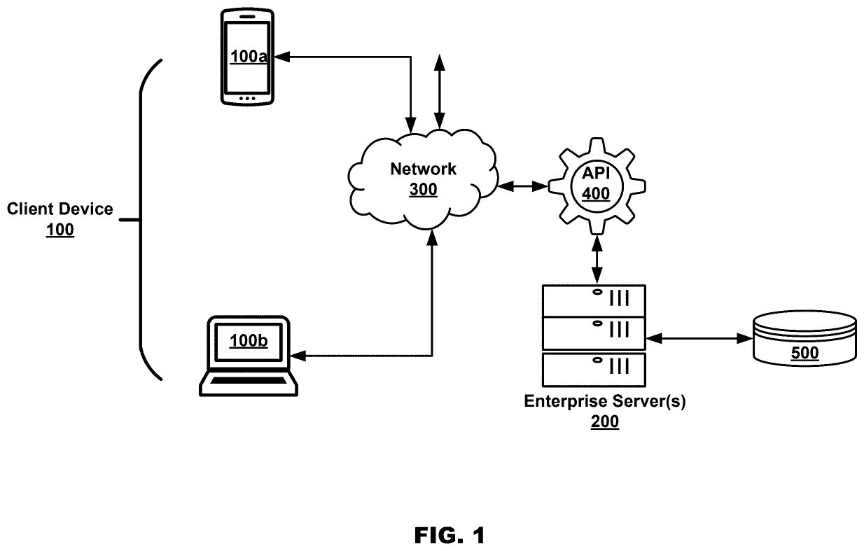

Turning to the figures, in which FIG. 1 illustrates a communication environment in which a client device 100 communicates with an enterprise over a communications network. The client device 100 operates in the communication environment to facilitate user access to and user management of one or more user accounts maintained by the enterprise via one or more enterprise servers 200. The communication environment includes the client device 100, one or more enterprise servers 200, an application programming interface (API) 500 for communications between the one or more enterprise servers 200 and the client device 100 via a host enterprise mobile application residing in an enterprise software application engine 222, and a storage location such as one or more databases 500.

In accordance with one or more embodiments, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes the performance and functionality of the one or more embodiments in a manner that falls within the spirit and scope of the principles of this disclosure.

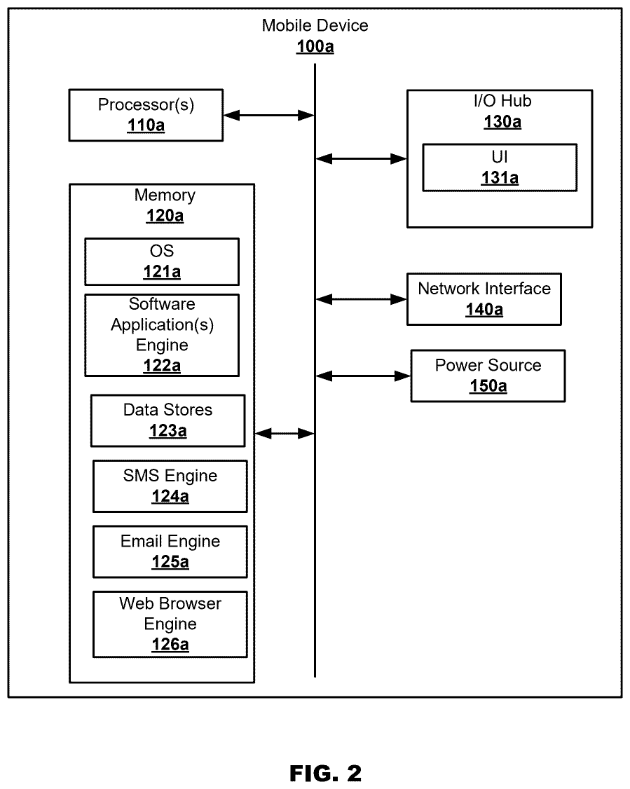

In the illustrated example embodiment of FIG. 2, the client device 100 (FIG. 1) comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of executable instructions of computer-executable program code. The set of executable instructions are executable by the one or more processors 110a to cause the one or more processors 110a to execute an operating system (OS) 121a and one or more software applications of a software application module 122a that reside in the memory 120a. The one or more software applications residing in the memory 120a includes, but is not limited to, an enterprise application residing in memory 220 and/or the enterprise software application engine 222 (FIG. 1). The enterprise application comprises a mobile enterprise application that facilitates establishment of a secure connection between the mobile device 100a and the one or more enterprise servers 200 (FIG. 1).

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 123a may be a component of the one or more processors 110a, or alternatively, may be operatively connected to the one or more processors 110a for use thereby. As set forth, described, and/or illustrated herein, “operatively connected” may include direct or indirect connections, including connections without direct physical contact.

The memory 120a also includes an SMS (short messaging service) module 124a operable to facilitate user transmission and receipt of text messages via the mobile device 100a though the network 300 (FIG. 1). An email module 125a is operable to facilitate user transmission and receipt of email messages via the mobile device 100a through the network 300 (FIG. 1). A user may utilize a web browser module 126a that is operable to facilitate user access to one or more enterprise websites through the network 300 (FIG. 1).

In accordance with one or more embodiments, the mobile device 100a includes an I/O hub 130a operatively connected to other systems and subsystems of the mobile device 100a. The I/O hub 130a may include one or more of an input interface, an output interface, and a network controller to facilitate communications between the client device 100 and the server 200 (FIG. 1). The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a includes a network interface 140a operable to facilitate connection to the network 300. The mobile device 100a also includes a power source 150a that comprises a wired powered source, a wireless power source, a replaceable battery source, or a rechargeable battery source.

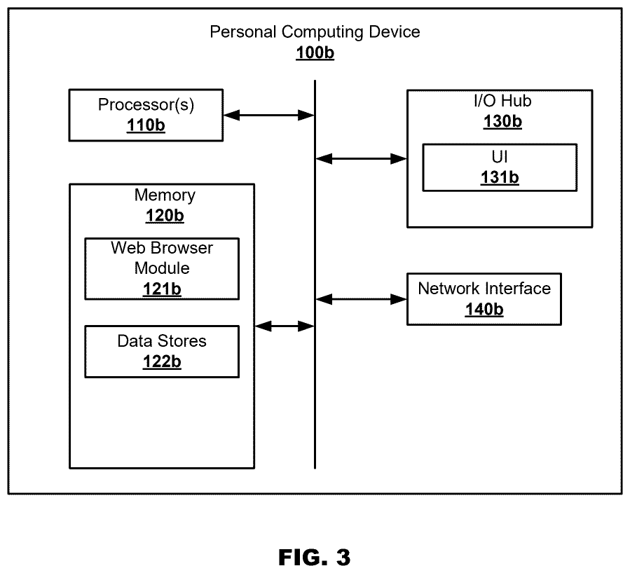

In the illustrated example embodiment of FIG. 3, the client device 100 (FIG. 1) comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110b, an I/O hub 130b, and a network interface 140b. The I/O hub 130b may include one or more of an input interface, an output interface, and a network controller to facilitate communications between the client device 100 and the server 200 (FIG. 2). The input interface and the output interface may be integrated as a single, unitary user interface 131b, or alternatively, be separate as independent interfaces that are operatively connected.

The memory 120b comprises a set of executable instructions of computer-executable program code. The set of executable instructions are executable by the one or more processors 110b to cause the one or more processors 110b to control the web browser module 121b in a manner that facilitates user access to a web browser having one or more enterprise websites through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122a may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110a (FIG. 2), 110b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110a (FIG. 2), 110b may comprise at least one hardware circuit (e.g., an integrated circuit) operable to carry out instructions contained in program code. In embodiments in which there is a plurality of processors, such processors may work independently from each other, or one or more processors may work in combination with each other.

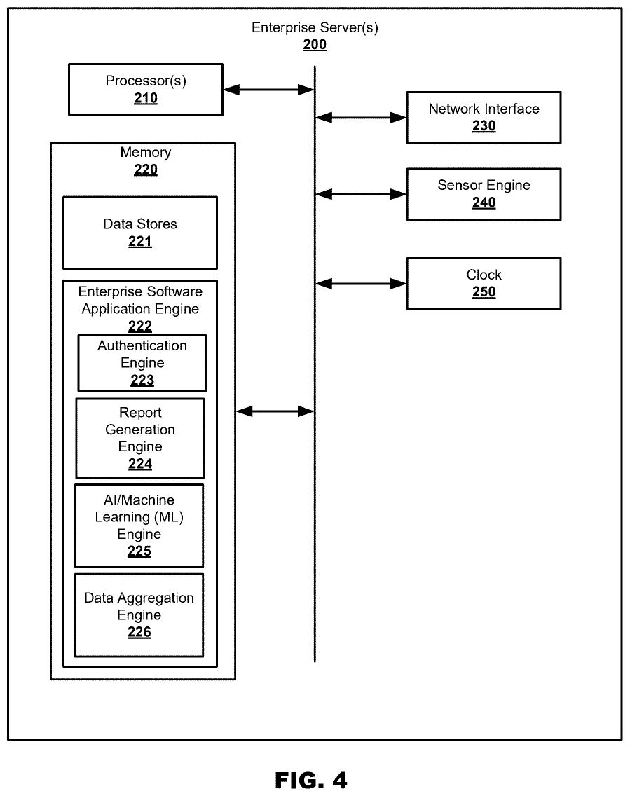

As illustrated in FIG. 4, the one or more enterprise servers 200 includes one or more processors 210, a non-transitory memory 220 operatively coupled to the one or more processors 210, a network interface 230, a sensor engine 240, and a clock 250 that is operable to perform time/temporal measurements. Some of the possible operational elements of each server in the one or more enterprise servers 200 are illustrated in FIG. 4 and will now be described herein. It will be understood that it is not necessary for each server in the one or more enterprise servers 200 to have all the elements illustrated in FIG. 4. For example, each server in the one or more enterprise servers 200 may have any combination of the various elements illustrated in FIG. 4. Moreover, each enterprise server in the one or more enterprise servers 200 may have additional elements to those illustrated in FIG. 4.

In accordance with one or more embodiments set forth, the one or more processors 210 may comprise artificial intelligence (AI) processors, machine learning (ML) processors, and combinations thereof that are operable to perform or otherwise implement accelerated processing of the one or more methods set forth and described herein.

In accordance with one or more embodiments set forth, described, and/or illustrated herein, the one or more enterprise servers 200 may be controlled by an enterprise system manager (or policy manager).

The memory 220 includes one or more data stores 221 that are operable to store one or more types of data, including but not limited to, user account data and user authentication data. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 comprises a set of executable instructions are executable by the one or more processors 210 in a manner that facilitates control of a plurality of processor-implemented engines that includes an enterprise software application engine 222, an authentication engine 223, a report generator engine 224, an AI/ML engine 225, and a data aggregation engine 226 that reside in the memory 220. In accordance with one or more embodiments set forth, described, and/or illustrated herein, the one or more enterprise servers 200 may individually or collectively execute the instructions to perform or otherwise implement any one or more of the methodologies set forth, described, and illustrated herein.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by the one or more enterprise servers 200, such that the instructions, when executed by the one or more processors 210, cause the one or more processors 210 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to execute certain logic, data-processing, and data-storing functions of the one or more enterprise servers 200, in addition to certain communication functions of the one or more enterprise servers 200. The enterprise software application engine 222, via the mobile application API 500, is operable to communicate with the client device 100 (having launched an enterprise mobile application). The data exchanged between the client device 100 and the one or more enterprise servers 200 may be encrypted during communications therebetween using a data encryption process. The computer-executable program code may instruct the one or more processors 210 to conduct the data encryption process by performing operations that include: deploying a key generation algorithm that generates a symmetric encryption/decryption key; and deploying an encryption algorithm using the encryption key to transform the data to an unreadable, encrypted format. The data may be decrypted through a data decryption process that includes deploying a decryption algorithm using the decryption key to transform the encrypted data to its original, readable format.

The authentication engine 223 is operable to verify the identity of the client device 100 by implementing one or more authentication protocols that map client device authentication credentials to stored authentication credentials. The authentication protocols may include multi-factor authentication, biometric authentication, password-based authentication, token-based biometric authentication, etc. The authentication engine 223 is operable to deploy the data encryption process to encrypt the authentication credentials in order to protect user sensitive data. The authentication engine 223 is operable to then securely store the encrypted authentication credentials at a storage location (e.g., databases 500). Upon the capture of authentication credentials by the one or more enterprise servers 200, the authentication engine 223 is operable to verify the validity of the authentication credentials by mapping the captured authentication credentials to the stored encrypted authentication credentials. Should the captured authentication credentials match the stored encrypted authentication credentials, the identity of the user and/or the client device 100 is confirmed.

The report generator engine 224 is operable to generate a data structure in a predefined format as a generated data structure for display on the UI 131a, 131b of the client device 100. The computer-executable program code may instruct the one or more processors 210 to cause the report generator engine 224 to extract data from an identified source data structure among a plurality of source data structures as extracted data, transmit the extracted data to the data aggregation engine. Alternatively, the computer-executable program code may instruct the one or more processors 210 to cause the report generator engine 224 to extract data from a plurality of target data structures as extracted data. The source data structures and the target data structures may reside in internal enterprise sources and/or external, third-party sources, such as memory 220 and/or the databases 500.

The report generator engine 224 may include a GUI engine for rendering a GUI that displays the generated data structure on the UI 131a, 131b of the client device 100. The report generator engine 224 may generate the data structure in one or more different formats. One example format comprises JavaScript Object Notation (JSON).

The AI/ML engine 225 may comprise one or more AI/ML processors operable to perform or otherwise implement accelerated processing of the one or more methods set forth and described herein. The one or more AI/ML processors are operable to perform operations involving machine learning (ML) by generating a trained ML model. The AI/ML engine 225 include one or more ML algorithms to train one or more machine learning models as a trained ML model based on data and/or information residing in the memory 220 and/or one or more storage locations (e.g., databases 500). The ML algorithms may include one or more of a linear regression algorithm, a logical regression algorithm, or a combination of different algorithms. A neural network may also be used to train the system based on the received data. The AI/ML engine 225 may analyze the received data and/or information, and transform the data and/or information in a manner which provides enhanced communication between the client device 100 and the one or more enterprise servers 200. The data and/or information may also be up-linked to other systems and modules in the one or more enterprise servers 200 for further processing to discover additional information that may be used to enhance the understanding of the information.

The computer-executable program code may instruct the one or more processors 210 to cause the AI/ML engine 225 to conduct preliminary screening and/or sanitizing of the source data structures and/or target data structures before extraction. To ensure the quality of the data, the AI/ML engine 225 is operable to perform data curation by verifying the accuracy of the data by detecting malicious code/malware that is embedded in the source data structures and/or target data structures, and automatically transmit an alert indicating the detection. This advantageously accelerates the processing of the data while also maintaining data accuracy. The computer-executable program code may instruct the one or more processors 210 to cause the AI/ML engine 225 to automatically summarize the aggregated data and identify errors. The malicious code may subsequently be used as a training data to aid in detecting future instances of malicious code.

The data aggregation engine 226 is operable to perform several tasks with respect to the aggregation of data. For example, the computer-executable program code may instruct the one or more processors 210 to cause the data aggregation engine 226 to acquire the extracted data from the report generator engine 224, and then aggregate the extracted data as aggregated data. The extracted data may then be transmitted to the AI/ML engine 225 for summarization of the extracted data.

The sensor engine 240 is operable to dynamically detect, determine, assess, monitor, measure, quantify, and/or sense information about the client device 100. The sensor engine 240 may be operable to detect, determine, assess, monitor, measure, quantify and/or sense in real-time. The sensor engine 240 may be operable to detect, determine, assess, monitor, measure, quantify, and/or sense geographic location information about the geographic location of the client device 100.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, the client device 100 and the one or more enterprise servers 200 could function in a fully virtualized environment. A virtual machine is where all hardware is virtual and operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment.

For example, a virtual hard disk can store the operating system, data, and application files for a virtual machine. Virtualized computer system includes computing device or physical hardware platform, virtualization software running on hardware platform, and one or more virtual machines running on hardware platform by way of virtualization software. Virtualization software is therefore logically interposed between the physical hardware of hardware platform and guest system software running “in” virtual machine. Memory of the hardware platform may store virtualization software and guest system software running in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

### Example: Report Generation From a Plurality of ServiceNow®-Generated Tables Using JavaScript

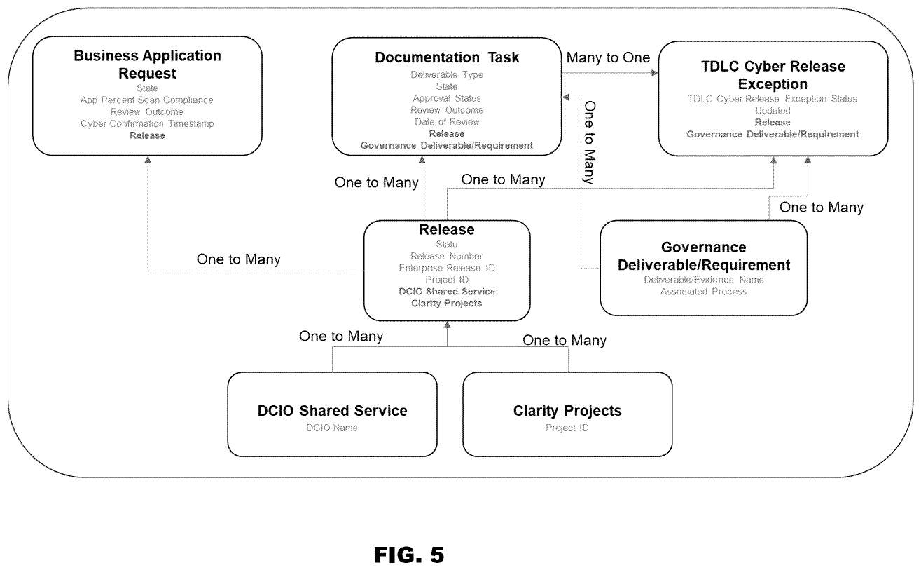

FIG. 5 shows an example of a ServiceNow® data model having complex relationships. The illustrated data model is designed for a custom application in ServiceNow®. In the illustrated example, performing a standard table join on the data from these tables natively in ServiceNow® creates many-to-many relationships that result in thousands of duplicate records. The best approach to resolve this scenario is to correct the data model. In this use case, however, higher priority items in the backlog may take precedence and push out the redesign effort by, for example, twelve months.

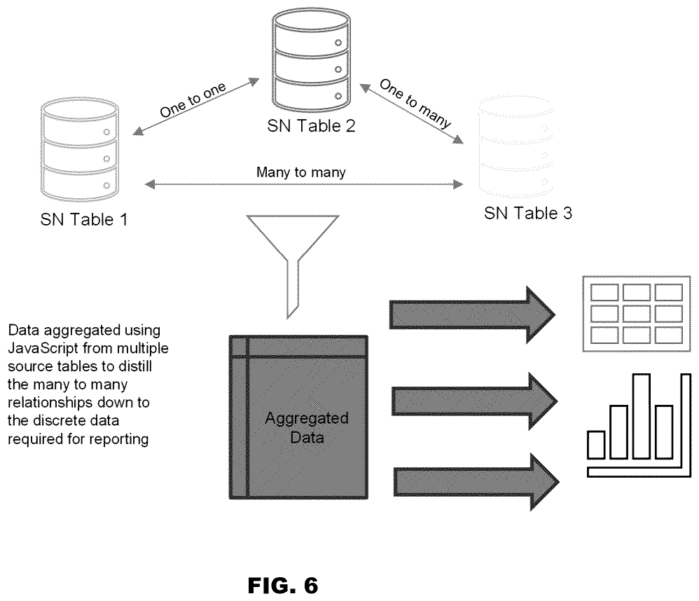

FIG. 6 shows a solution for generating reports from a plurality of ServiceNow®-generated tables where complex relationships (one-to-many, many-to-many) exist between the tables. The illustrated solution may generally be implemented in a server computing system such as, for example, the one or more enterprise servers 200 (FIGS. 1 and 4) already discussed herein. More particularly, the technology described herein involves extensive use of a programming language, such as, for example, Javascript®, to customize charts and reports. For example, Javascript® can be deployed to extract data from a plurality of tables (e.g., ServiceNow®/SN tables), then aggregate the extracted data to obtain a set of aggregated data, in which summaries from the set of aggregated data are used to create a data structure (e.g., a list chart) having calculated scores created within the list chart from the summarized data. Complex relationships between the tables are distilled to an enhanced software model for generating list reports, including calculated columns, score reports, and trend reports.

Heretofore, reporting solutions involved undesirable outcomes, including exporting data to Excel® for manual manipulation and data visualization, no design control, screenshotting Excel® data into Powerpoint® (PPT) for executive level summaries, incomplete dashboards in ServiceNow®, and placing SDLC reports on multiple tabs (e.g., leading to a poor user experience).

In accordance with the example embodiments, reporting solutions provide an enhanced user interface (UI) experience thru consolidation of reports into a comprehensive dashboard in-platform with filter options, greater user flexibility, an elevated user experience, design guidelines around a software platform reporting for consistency and quality, support for data integrity and ServiceNow® as source of truth, the ability to develop custom solutions through custom scripting, and greatly reduced manual effort to produce consistent reporting. Accordingly, aggregating data and preparing visualizations and summaries take less time (e.g., 32=>2 hours per month) and fewer separate tabs for user accessed reports (e.g., 42=>30 separate tabs and 25=>0 supporting tabs), wherein the reports can be provided to a high number of users on-demand (e.g., approximately 2000 leaders and delivery team members).

Implementation of the reporting use case also illuminated other opportunities that can benefit from the workflow used in the report, such as SDLC Compliance and Enterprise Technology Asset Management. Additionally, automation of this highly disseminated report frees up skilled resources for optimizing business processes. Moreover, the addition of the software platform to ServiceNow® instances highlights the importance of data management and strategy as part of teams' ongoing ServiceNow® roadmap to greater value.

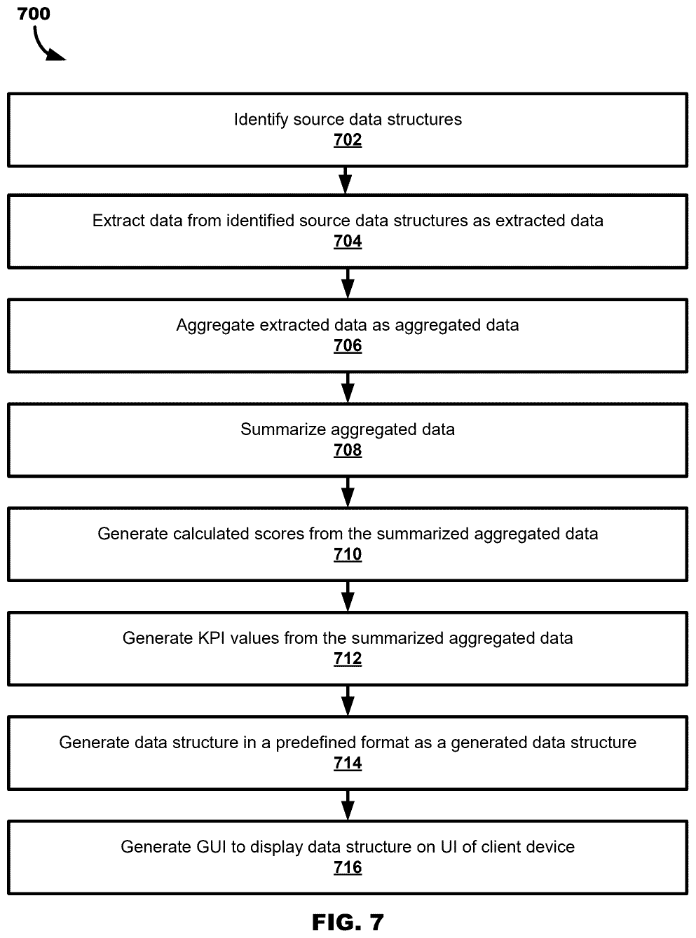

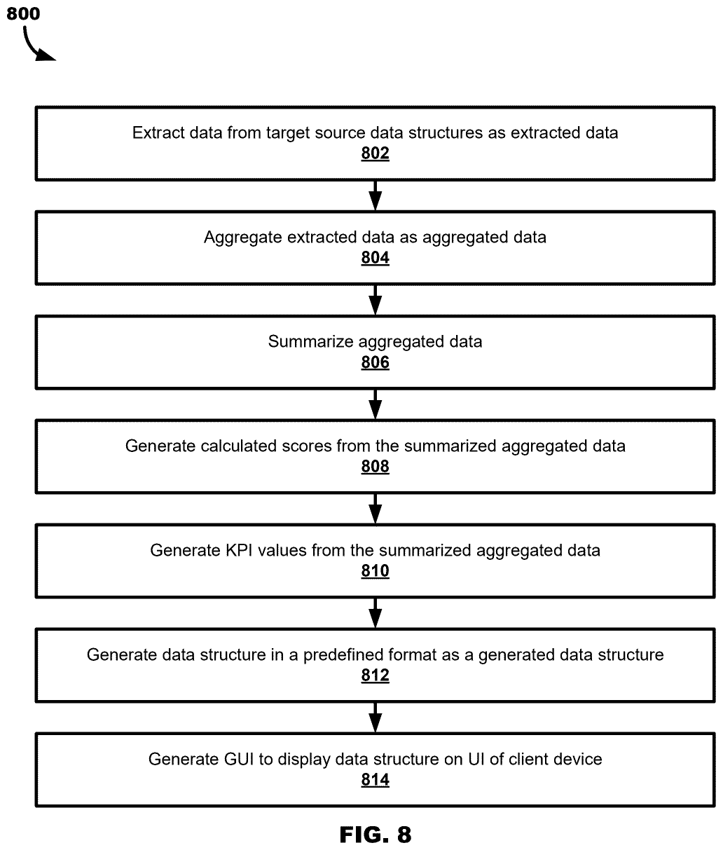

Illustrated examples shown in FIGS. 7 and 8 set forth methods 700 and 800. In one or more examples, the respective flowcharts of the methods 700 and 800 may be implemented by the one or more processors 210 of the one or more enterprise servers 200. In particular, the methods 700 and 800 may be implemented as one or more engines or modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, a report generating software platform launched/executed by the one or more enterprise servers 200 provides functionality described or illustrated herein. In particular, report generating software platform launched/executed by the one or more processors 210 is operable to perform one or more processing blocks of the methods 700 and 800 set forth, described, and/or illustrated herein, or provides functionality set forth, described, and/or illustrated.

As illustrated in FIG. 7, a method 700 includes illustrated process block 702, which includes identifying a plurality of source data structures. Alternatively or additionally, the source data structures may be identified by causing the AI/ML engine 225 to deploy a first trained ML model that is trained using one or more data sets as training data.

From illustrated process block 702, the method 700 proceeds to illustrated process block 704, which includes extracting data from each identified source data structure in the plurality of source data structures as extracted data. Alternatively or additionally, the data from the identified source data structure may be extracted by activating the report generator engine 224.

From illustrated process block 704, the method 700 proceeds to illustrated process block 706, which includes aggregating the extracted data as aggregated data. Alternatively or additionally, the extracted data may be captured or acquired from the report generator engine 224 to the data aggregation engine in order that the extracted data may be automatically aggregated.

From illustrated process block 706, the method 700 proceeds to illustrated process block 708, which includes summarizing the aggregated data. Alternatively or additionally, the aggregated data may be summarized by causing the AI/ML engine 225 to deploy a second trained ML model that is trained using one or more data sets as training data.

From illustrated process block 708, the method 700 proceeds to illustrated process block 710, which includes generating calculated scores from the summarized aggregated data. Alternatively or additionally, calculated scores may be generated by causing the AI/ML engine 225 to deploy a third trained ML model that is trained using one or more data sets as training data.

From illustrated process block 710, the method 700 proceeds to illustrated process block 712, which includes generating Key Performance Indicator (KPI) values from the summarized aggregated data. Alternatively or additionally, the KPI values may be generated by causing the AI/ML engine 225 to deploy a fourth trained ML model that is trained using one or more data sets as training data.

From illustrated process block 712, the method 700 proceeds to illustrated process block 714, which includes generating, based on the summarized data, a data structure in a predefined format as a generated data structure. Alternatively or additionally, the data structure may be generated by causing the AI/ML engine 225 to deploy a fifth trained ML model that is trained using one or more data sets as training data. Alternatively or additionally, the data structure may be generated by activating the report generation engine 224.

From illustrated process block 714, the method 700 proceeds to illustrated process block 716, which includes generating a GUI to display the generated data structure on a user interface (UI) of a client device. Alternatively or additionally, the GUI may be generated by activating the report generation engine 224.

As illustrated in FIG. 8, a method 800 includes illustrated process block 802, which includes extracting data from a plurality of target source data structures as extracted data. Alternatively or additionally, the data from the plurality of target source data structures may be extracted by activating the report generator engine 224.

From illustrated process block 802, the method 800 proceeds to illustrated process block 804, which includes aggregating the extracted data as aggregated data. Alternatively or additionally, the extracted data may be captured or acquired from the report generator engine 224 to the data aggregation engine in order that the extracted data may be automatically aggregated.

From illustrated process block 804, the method 800 proceeds to illustrated process block 806, which includes summarizing the aggregated data. Alternatively or additionally, the aggregated data may be summarized by causing the AI/ML engine 225 to deploy a second trained ML model that is trained using one or more data sets as training data.

From illustrated process block 806, the method 800 proceeds to illustrated process block 808, which includes generating calculated scores from the summarized aggregated data. Alternatively or additionally, calculated scores may be generated by causing the AI/ML engine 225 to deploy a third trained ML model that is trained using one or more data sets as training data.

From illustrated process block 808, the method 800 proceeds to illustrated process block 810, which includes generating Key Performance Indicator (KPI) values from the summarized aggregated data. Alternatively or additionally, the KPI values may be generated by causing the AI/ML engine 225 to deploy a fourth trained ML model that is trained using one or more data sets as training data.

From illustrated process block 810, the method 800 proceeds to illustrated process block 812, which includes generating, based on the summarized data, a data structure in a predefined format as a generated data structure. Alternatively or additionally, the data structure may be generated by causing the AI/ML engine 225 to deploy a fifth trained ML model that is trained using one or more data sets as training data. Alternatively or additionally, the data structure may be generated by activating the report generation engine 224.

From illustrated process block 812, the method 800 proceeds to illustrated process block 814, which includes generating a GUI to display the generated data structure on a user interface (UI) of a client device. Alternatively or additionally, the GUI may be generated by activating the report generation engine 224.

The system and method advantageously provides for automated report generation from multiple source data structures, including relational tables with one-to-one, one-to-many, and many-to-many relationships, to produce a cohesive operational report in a predefined format. The predefined format of the generated data structure includes calculated columns, score reports, and trend reports, enabling dynamic and customizable reporting for SDLC compliance and other enterprise processes. The system generates calculated scores from the summarized aggregated data, which are then incorporated into the list chart for real-time performance tracking and analysis. The system may be implemented using JavaScript to customize charts and reports within ServiceNow, enabling in-platform report generation without reliance on external tools like Excel or PowerPoint. The AI/ML engine performs data curation by detecting malicious code or malware embedded in source or target data structures and automatically transmitting alerts for remediation.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A method for optimized report generation, comprising:
identifying a plurality of source data structures;
extracting data from each identified source data structure in the plurality of source data structures as extracted data;
aggregating the extracted data as aggregated data;
summarizing the aggregated data; and
generating, based on the summarized data, a data structure in a predefined format as a generated data structure.

2. The method of claim 1, wherein the plurality of source data structures comprise relational tables.

3. The method of claim 2, wherein two or more of the plurality of source data structures have a one-to-one relationship.

4. The method of claim 3, wherein two or more of the plurality of source data structures have a one-to-many relationship.

5. The method of claim 3, wherein two or more of the plurality of source data structures have a many-to-many relationship.

6. The method of claim 1, wherein the generated data structure comprises a list chart.

7. The method of claim 6, wherein the predefined format comprises calculated columns.

8. The method of claim 6, wherein the predefined format comprises score reports.

9. The method of claim 6, wherein the predefined format comprises or trend reports.

10. The method of claim 6, further comprising generating calculated scores from the summarized aggregated data.

11. The method of claim 10, wherein the list chart includes the generated calculated scores.

12. The method of claim 6, further comprising generating Key Performance Indicator (KPI) values from the summarized aggregated data.

13. The method of claim 12, wherein the list chart includes the generated KPI values.

14. The method of claim 1, wherein aggregating the extracted data comprises deploying a software model to aggregate the extracted data as the aggregated data.

15. The method of claim 1, wherein extracting the data from the plurality of source data structures comprises sequentially extracting the data from the plurality of source data structures.

16. The method of claim 1, wherein extracting the data from the plurality of source data structures comprises simultaneously extracting the data from the plurality of source data structures.

17. The method of claim 1, further comprising generating a graphical user interface (GUI) to display the generated data structure on a user interface (UI) of a client device.

18. The method of claim 1, further comprising automatically updating the generated data structure as an updated data structure and storing the updated data structure at a storage location.

19. At least one computer readable storage medium comprising a plurality of instructions, which when executed by a computing system, cause the computing system to perform operations including:
identifying a plurality of source data structures;
extracting data from each identified source data structure in the plurality of source data structures as extracted data;
aggregating the extracted data as aggregated data;
summarizing the aggregated data; and
generating, based on the summarized data, a data structure in a predefined format as a generated data structure.

20. A computing system, comprising:
one or more processors and a non-transitory memory coupled to the one or more processors, the non-transitory memory including a set of executable instructions of computer-executable program code, which when executed by the one or more processors, cause the one or more processors to perform operations including:
identifying a plurality of source data structures;
extracting data from each identified source data structure in the plurality of source data structures as extracted data;
aggregating the extracted data as aggregated data;
summarizing the aggregated data; and
generating, based on the summarized data, a data structure in a predefined format as a generated data structure.
